(19) United States
(12) Patent Application Publication
(10) Pub. No.: US 2014/0000099 A1
(43) Pub. Date: Jan. 2, 2014

(54) METHODS FOR BUILDING RESISTIVE ELEMENTS INTO PRINTED CIRCUIT BOARDS

(71) Applicants: Noah Austin Spivak, Oak Hill, VA (US); Emilie G. Casey, Montgomery Village, MD (US)

(72) Inventors: Noah Austin Spivak, Oak Hill, VA (US); Emilie G. Casey, Montgomery Village, MD (US)

(21) Appl. No.: 13/537,937

(22) Filed: Jun. 29, 2012

(51) Int. Cl. H01C 17/02

(52) U.S. Cl. 29/613

(57) ABSTRACT

A method for building resistive elements into any printed circuit board. Holes are created on said board and filled with resistive material. The top and bottom of the etched pads that contain the resistive material are over plated with an electrically conductive material. This structure now forms a vertical resistive via and substantially reduces the overall area need for resistors.

### BACKGROUND OF THE INVENTION

1. Field of the Invention

The present invention relates to methods for building resistive elements into printed circuit boards. More particularly, the present invention relates to methods for building a vertical resistive via into printed circuit boards.

Printed circuit boards are now widely used in all kinds of electronic devices. When manufacturing printed circuit boards, there are currently two common methods to build resistive elements into integrated circuit boards: 1) affixing a resistor component to the board, or 2) running sufficient conductive material across the horizontal surface of the board until the proper resistance is achieved. Both of these methods take up a certain amount of the precious space on the board, and at least for the first method, requires a separate resistor component to be acquired and installed.

What is in need is a method by which a desirable resistor is built and at the same time saving the precious space on the board.

2. Description of Related Art

Some related prior inventions are disclosed as prior art herein. Several patents exist for resistors on integrated circuits. More specifically, by way of example, U.S. Pat. No. 7,891,890 discloses a method using resistor component parts. U.S. Pat. No. 7,277,005 discloses a method using a slot to hold resistive materials and connected horizontally, taking up valuable space.

### SUMMARY OF THE INVENTION

In an exemplary embodiment of the present invention, there is disclosed a method for building resistive elements into any printed circuit board. More particularly, the present invention discloses a method for building resistive elements into any printed circuit board by creating the vertical resistive via using standard through hole or laser/controlled depth technology. Vertical Resistive Via uses a simplified design whereby vertical holes are drilled through the board itself. Then the holes are filled or dipped in resistive material. This material is mixed specifically to match a certain resistance value. The top and bottom of the etched pads that contain the resistive material are over plated with an electrically conductive material. This structure now forms a resistive via that travels vertically through or between layers of a printed circuit board. So there is no need for a resistor component, the vertical width of the board itself, the via, serves as the resistor. This method substantially reduces the overall area need for resistors and the need to physically assemble them since they are now built into the printed circuit board itself. These structures could also be built around standard plated through vias but isolated from them, thus increasing their space saving ability. Because of their small form factor they will benefit overall signal integrity.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is an X-ray view of the printed circuit board with both top and bottom side images etched from the copper.

FIG. 2 is an X-ray view of a drill bit and holes drilling through the copper images on the top and bottom of the printed circuit board.

FIG. 3 is an X-ray view of a printed circuit board with resistive materials forced into holes thus filling up the barrels.

FIG. 4 is an X-ray view of a printed circuit board and the over plating on the top and bottom which sandwiches the resistive material and creates a through hole resistor that connects the etch image top to bottom.

FIG. 5A and FIG. 5B shows the comparison between the traditional surface mount resistor and the new through hole resistive via, saving valuable space on the board.

### DESCRIPTION OF THE PREFERRED EMBODIMENT

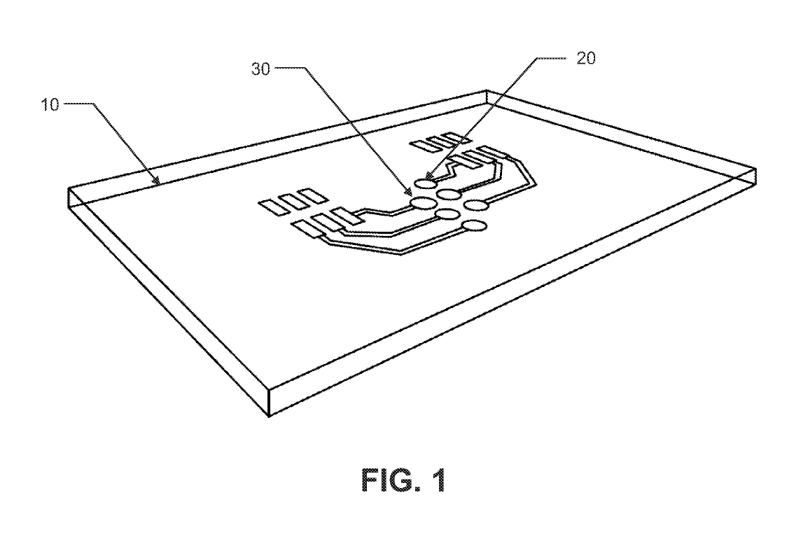

Referring to FIG. 1 through FIG. 5B, there is disclosed a method for building resistive elements into any printed circuit board. More particularly, the present invention discloses a method for building resistive elements into any printed circuit board by creating the vertical resistive via using standard through hole or laser/controlled depth technology.

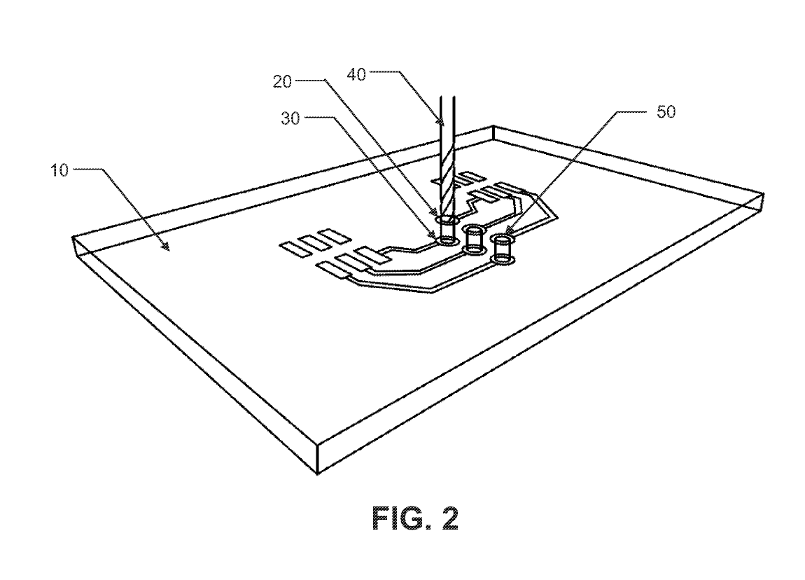

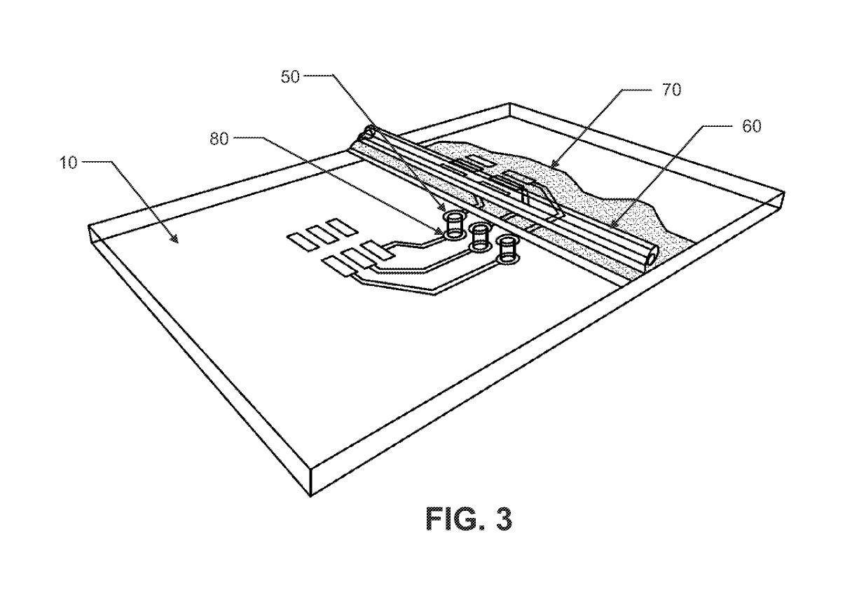

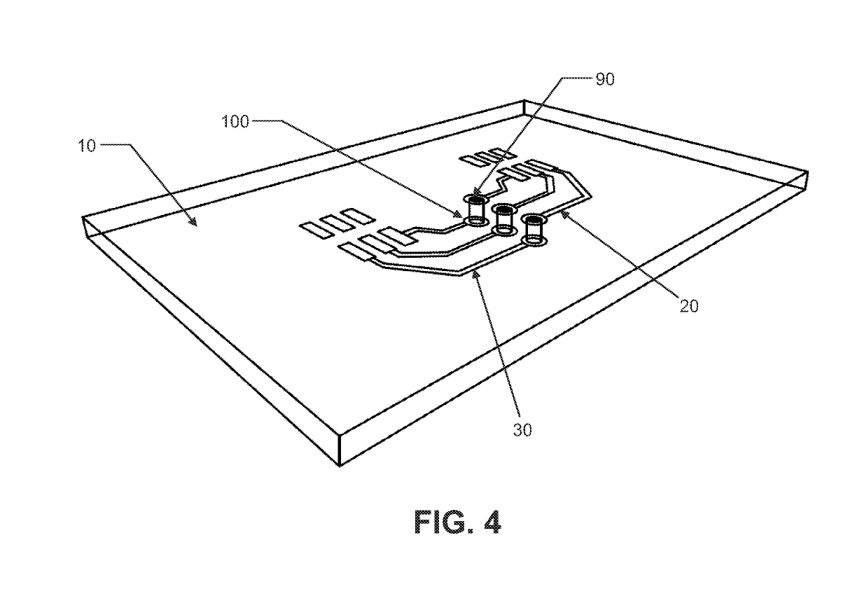

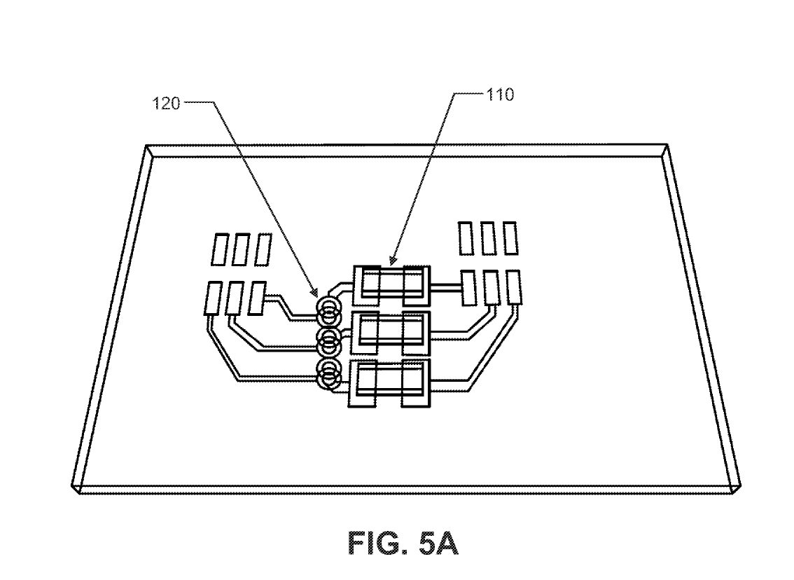

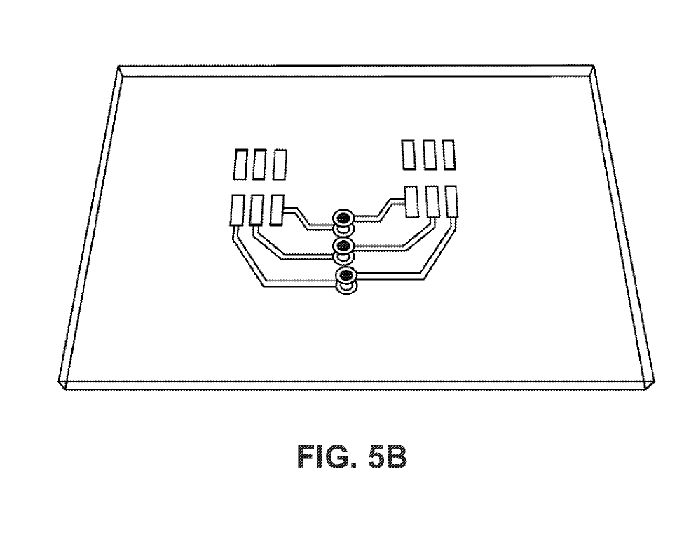

To build a Vertical Resistive Via on a printed circuit board 10 with both top 20 and bottom 30 side images etched from the copper (FIG. 1), holes 50 are drilled through the copper images on the top 20 and bottom 30 of the printed circuit board 10 using hole making means 40 (FIG. 2). Then the holes 50 are filled or dipped in with resistive materials 70 using filling means 60 to force said resistive materials into the hole barrels 80 (FIG. 3). This material is mixed specifically to match a certain resistance value. Then the top and bottom of the etched pads that contain the resistive material are over plated with an electrically conductive material, 90 for top and 100 for bottom (FIG. 4). The over plating on the top 90 and bottom 100 sandwiches said filled resistive materials thus creates a through hole resistor, called hereafter as Vertical Hole Via, that connects the etch image top 20 and bottom 30 of a printed circuit board 10 (FIG. 4). This structure now forms a resistive via that travels vertically through or between layers of a printed circuit board, thus there is no need for a resistor component. The vertical width of the board itself, the via, serves as the resistor. This method substantially reduces the overall space need for traditional resistors (110 and 120 in FIG. 5A) and the need to physically assemble them since they are now built into the printed circuit board itself, as seen in FIG. 5A and 5B. These structures could also be built around standard plated through vias but isolated from them, thus increasing their space saving ability. Because of their small form factor they will benefit overall signal integrity.

In one embodiment of the present invention, standard through holes are used to create vertical resistive vias. In another embodiment of the present invention, internal buried holes that are not seen from the top or bottom of the printed circuit board are used to create vertical resistive vias. In another embodiment of the present invention, external blind holes that are only seen from either the top or bottom of the printed circuit board are used to create vertical resistive vias.

In one embodiment of the present invention, the hole making means use standard drill bits. In another embodiment of the present invention, the hole making means use laser drills. In another embodiment of the present invention, the hole making means use controlled depth drilling.

In one embodiment of the present invention, the over plated electrically conductive material which sandwiches filled-in resistive materials may include a standard plated via, plated laser via or plated controlled depth via. In another embodiment of the present invention, the over plated via is placed within the resistively filled hole but isolated from the resistive element so it further enables space savings on the printed circuit board.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A method for building resistive elements into any printed circuit board, comprising:
a. creating holes on said board using hole making means;
b. filling said holes with resistive material; and
c. over plating on the top and bottom of said filled-in resistive material with an electrically conductive material to form a vertical resistor in said board.

2. A method for building resistive elements into any printed circuit board of claim 1, wherein said holes include standard through holes, internal holes that are not seen from the top or bottom of said board, and external blind holes that are only seen from either the top or the bottom of said board.

3. A method for building resistive elements into any printed circuit board of claim 1, wherein said hole making means may include standard drill through device, laser drills, and controlled depth drilling device.

4. A method for building resistive elements into any printed circuit board of claim 1, wherein standard through holes are filled with resistive materials to match a given resistive value and over plated on the top and bottom with an electrically conductive material which forms a vertical resistor in a printed circuit board.

5. A method for building resistive elements into any printed circuit board of claim 1, wherein said holes are internal buried holes that are not seen from the top or bottom of said board and built using standard lamination processes.

6. A method for building resistive elements into any printed circuit board of claim 1, wherein said holes are internal stacked holes that are not seen from the top or bottom of said board and built using laser drills and standard lamination processes.

7. A method for building resistive elements into any printed circuit board of claim 1, wherein said holes are external blind holes that are only seen from either the top or bottom of said board and built using laser or controlled depth drilling.

8. A method for building resistive elements into any printed circuit board of claim 1, wherein said over-plated electrically conductive material includes a standard plated via, plated laser via or plated controlled depth via.

9. A method for building resistive elements into any printed circuit board of claim 8, wherein said standard plated via, plated laser via or plated controlled depth via is placed within the resistively filled hole but isolated from the resistive element so it further enables space savings on said board.
